(19) United States
(12) Patent Application Publication
(10) Pub. No.: US 2015/0183269 A1
(43) Pub. Date: Jul. 2, 2015

(54) FOLDABLE TIRE, FOLDING METHOD AND USE

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventor: Christophe Laurent, Clermont-Ferrand (FR)

(73) Assignees: MICHELIN RECHERCHE ET TECHNIQUE, S.A., Granges-Paccot (CH); COMPAGNIE GENERALE DES ETABLISSEMENTS MICHELIN, Clermont-Ferrand (FR)

(21) Appl. No.: 14/410,284

(22) PCT Filed: Jun. 19, 2013
(86) PCT No.: PCT/EP2013/062698

§ 371 Date: Dec. 22, 2014

(30) Foreign Application Priority Data
Jun. 27, 2012 (FR) 1256127

(51) Int. Cl. B60C 3/08; B60C 5/00; B60C 15/04

(52) U.S. Cl. CPC B60C 3/08; B60C 15/04; B60C 5/00

(57) ABSTRACT

A collapsible tire for a motorized two-wheeled vehicle, containing a carcass reinforcement possibly surmounted radially from the outside by an inextensible crown reinforcement, itself radially on the inside of a tread, the reinforcements each containing at least one layer of reinforcing elements, the tread connected to two beads by two sidewalls, the beads intended to come into contact with a rim, each bead containing at least one circumferential reinforcing element called a bead wire, the bead wire defining a mean line forming a substantially circular closed curve in a circumferential plane. The bead wire is flexible and contains at least one concave part P_{c} of smaller radius R_{c} and of center of curvature C_{c}, and contains at least one unwrapped metal cord the carbon content of which is comprised between 0.5 and 0.9%. A method of collapsing the tire and to a use of the tire.

This application is a 371 national phase entry of PCT/EP2013/062698, filed 19 Jun. 2013, which claims benefit of French Patent Application No. 1256127, filed 27 Jun. 2012, the entire contents of which are incorporated herein by reference for all purposes.

### BACKGROUND

1. Field

The disclosure relates to a radial tire or cross-ply tire for a motorized two-wheeled vehicle of the motorbike type, which is collapsible, to a method of collapsing and to a method of using the tire for a motorized two-wheeled vehicle of the motorbike type.

2. Description of Related Art

The following definitions apply in what follows:
a “circumferential plane” means a plane perpendicular to the axis of rotation of the tire,
an “equatorial plane” means a circumferential plane passing through the middle of the tread surface of the tire, and
a “radial plane” means a plane containing the axis of rotation of the tire,
an “axial direction” means a direction parallel to the axis of rotation of the tire,
a “radial direction” means a direction intersecting the axis of rotation of the tire and perpendicular thereto,
a “circumferential direction” means a direction tangential to the surface of the tread in the direction of rotation of the tire,
“radially on the inside of” means closer to the axis of rotation of the tire,
“radially on the outside of” means further from the axis of rotation of the tire,
“axially on the inside of” means closer to the equatorial plane,
“axially on the outside of” means further away from the equatorial plane.

A tire comprises a tread intended to come into contact with the ground via a tread surface, extending radially towards the inside in the form of two sidewalls connected to two beads intended to provide the connection between the tire and a rim.

A radial tire for a motorized two-wheeled vehicle comprises at least one carcass reinforcement each end of which is anchored in a bead by being turned up around a circumferential reinforcing element called a bead wire, and possibly a reinforcement comprising a crown reinforcement radially on the inside of the tread.

The cross-ply tire for a motorized two-wheeled vehicle differs from the radial tire for a two-wheeled vehicle in that the angle of the carcass ply considered at the centre of the tread is less than 65°.

The bead wire may be formed of an assembly of elementary threads or of cords, themselves formed of an assembly of elementary threads.

The crown reinforcement, when there is one, generally comprises one to two plies conventionally referred to as “crown plies”. These crown plies may usually be compared to a sandwich of textile cords sandwiched between two layers of rubber.

In the case of a tire for a motorized two-wheeled vehicle, the thickness of the crown reinforcement, which essentially consists of the radial stack of the crown reinforcement, if there is one, and of the carcass reinforcement is usually comprised between 2 and 4 mm. A sidewall of a tire for a motorized two-wheeled vehicle generally has a thickness comprised between 2 and 7 mm, when the sidewall thickness is defined as the thickness of the sidewall and that of the carcass ply.

A collapsible tire for a bicycle, comprising a carcass reinforcement each end of which is anchored in two beads by being turned up around a reinforcing element called a bead wire is already known from document WO 10/100088. Each bead is extended radially by sidewalls which join to a tread. This tire comprises a bead wire formed by winding a saturated and unwrapped metal cord formed of filaments.

Unlike tires for bicycles, the speed of which is implicitly limited to 100 km/h (because there is no speed rating on bicycle tires), tires for motorized two-wheelers may reach speeds of as much as more than 300 km/h.

Moreover, when the tires are manufactured at production sites distant from the sales sites it is necessary to transport them. When they are being transported, even if compressed together, the tires still occupy a substantial volume.

Specifically, one mode of packaging currently employed is first of all to lay a first row of tires vertically and in a line to make an angle of inclination with the ground so that they are partially superposed. Other tires are then incorporated and pushed into that part of the hole of each tire of the first row that has been left free, thus forming a second row. Such a mode of packaging allows 30% more tires to be packed in per m³ by comparison with a layout in which the tires are placed side by side without deformation. Another storage mode involves storing the tires vertically and connecting them in groups of five.

Hence, a need to be able to package one or more tires for a motorized two-wheeled vehicle, not mounted on rim, in a more or less compact manner for the time they spend in transport and/or in storage, and without damaging their internal structure while at the same time allowing them to revert very quickly back to their initial shape when they are no longer collapsed, still remains.

### SUMMARY

One subject or embodiment of the invention is a collapsible tire for a motorized two-wheeled vehicle, comprising a carcass reinforcement possibly surmounted radially on the outside by an inextensible crown reinforcement, itself radially on the inside of a tread, the reinforcements each consisting of at least one layer of reinforcing elements, the tread being connected to two beads by two sidewalls, the beads being intended to come into contact with a rim, each bead comprising at least one inextensible circumferential reinforcing element called a bead wire, the bead wire defining a mean line forming a substantially circular closed curve in a circumferential plane, the sidewalls having a thickness comprised between 2 and 7 mm and the crown reinforcement having a thickness comprised between 2 and 3 mm. The thickness of the sidewall corresponds to the combined thickness of the sidewall and that of the carcass ply.

The bead wire of each bead is flexible. The tire is characterized in that, after the tire has been collapsed, the mean line of the bead wire comprises at least one concave part P_{c} of smaller radius R_{c} and of centre of curvature C_{c}, and in that the bead wire comprises at least one unwrapped metal cord, the carbon content of which is comprised between 0.5 and 0.9%.

This range of carbon content values makes it possible to increase the strength of the cord and thus reduce the number of turns of cord that make up the bead wire.

A bead wire is the said to be flexible when, flexed in its plane about a pulley of 10 mm radius, none of the rigid elements of which it is made suffers permanent deformation.

According to an embodiment of the invention, a crown reinforcement is inextensible when the load to deform it by 5% is at least equal to 40 N, and a bead wire is inextensible when the load to lengthen it by 1% is at least equal to 2500 N.

The tire according to an embodiment of the invention has the advantage that the number of tires per unit volume during transport and/or storage can be increased significantly, thus leading to substantial economic savings.

Specifically, the form of collapse according to an embodiment of the invention allows tires to be stored with an improvement of 30% per m³ notably with respect to the mode of packaging known as lacing, explained earlier. The tire according to an embodiment of the invention can be collapsed and stored loose or in a case.

Another advantage of the tire of an embodiment of the invention is that it can be collapsed in various ways and kept collapsed in those ways, regardless of its size. Finally, the tire according to an embodiment of the invention can remain collapsed for the time it spends in transport and/or storage without any negative impact on its performance.

Another subject or embodiment of the invention is a method for collapsing a tire as defined previously, which includes:

a) parting, in a radial plane, the beads of a first half of a tire in an axial direction towards an axis tangential to the centre of the tread,
b) applying a force in two parallel radial directions of identical sense, at two spaced-apart points on the tread of a first half (M₁) so as to bring the first half (M₁) of the parted tread closer to a second half (M₂) opposite the first half (M₁) at these two points, thus forming a first and a second closer-together zone, while at the same time keeping the tread between these two points in the form of a protrusion,
c) arranging the internal part of the protrusion on each side of a first vertical axis, which is fixed and, at the same time, causing to bear against a third vertical axis, one of the closer-together zones, the first axis being arranged diametrically to a second axis, the first and second vertical axes being placed on a flat means able to function in rotation,
d) causing the flat means to effect at least one rotation so as to collapse the tire by coiling it on itself about the first and third vertical axes.
The parting step means increasing the axial distance between the beads.

Finally, a subject or embodiment of the invention is the use of the tire as defined hereinabove for a two-wheeled vehicle of the motorbike type.

The bead wire of each bead is preferably formed by winding at least one metal cord, formed of filaments, which is saturated and unwrapped and the diameter of the cord of which is preferably less than 0.22 mm. This bead wire is dimensioned in such a way that the burst pressure is higher than the capability of the automatic inflation tools the maximum pressure of which is comprised between 10 and 12 bar.

The ability of the cord to be bent is dependent on the number of metal cords laid. For preference, use is made of a very high strength (between 1700N and 2200N) steel cord so as to reduce the number of turns of cord laid. This offers the advantage also of reducing the mass of the collapsed tires, which in some instances can be limited by their mass (the bead wire representing between 5 and 10% of the total mass of the tire) whereas when transported in the non-collapsed state, they are limited by volume.

The mean line of the bead wire further comprises at least two points of inflexion I₁, I₂ delimiting the concave part P_{c}.

The mean line of the bead wire further comprises at least two convex parts Pₓ₁, Pₓ₂ having two smaller radii Rₓ₁, Rₓ₂ and two centres of curvature Cₓ₁, Cₓ₂. Preferably, straight lines D₁, D₂ respectively connecting the centre of curvature C_{c1} of the concave part P_{c} to each of the centres of curvature Cₓ₁, Cₓ₂ of the convex parts form an angle comprised between 5° and 130°.

The concave part P_{c} is defined by a centre of curvature on the outside of the closed mean line of the bead wire. The convex part Pₓ is defined by a centre of curvature on the inside of the closed mean line of the bead wire.

The mean line of the bead wire of each bead is preferably formed by winding a metal cord, formed of filaments. The diameter of the cord is preferably less than 1.5 mm, and is unwrapped. The diameter of the filaments is preferably less than 0.22 mm.

It is the said to be “unwrapped” when it has no additional filament wound in a helix on the external surface of the said cord. A wrapping filament is usually chosen to have a diameter less than that of the filaments of the cord and is wrapped at a short pitch and in a direction that is the opposite of or the same as the direction in which the threads that form the external surface of the cord are wound. The prime function of a wrap is to limit the buckling of the cord.

For preference also, the diameter of the threads or filaments that form the cord is less than 0.22 mm. Such filament diameters will further contribute to the flexibility of the cord and limit the loads necessary to collapse the tire.

One advantageous embodiment of the invention makes provision for the tensile modulus of the cord to be greater than 150 GPa.

Advantageously also, the cord can be bent into a radius of curvature comprised between 2 and 5 mm without suffering any deformation that would render the tire unusable. For preference, it can be bent to a radius of curvature less than 3 mm without suffering any deformation that would render the tire unusable.

According to one alternative form of the embodiment of the invention, the cord is a layered metal cord of [L+M] or [L+M+N] construction comprising a first layer C1 of L threads of diameter d₁ with L ranging from 1 to 4, surrounded by at least one intermediate layer C2 of M threads of diameter d₂ wound together in a helix at a pitch p₂ with M ranging from 3 to 12, the layer C2 possibly being surrounded by an external layer C3 of N threads of diameter d₃, wound together in a helix at a pitch p₃, with N ranging from 8 to 20.

When L is equal to 1, the first layer forms a central core consisting of a metal thread of diameter d₁.

Advantageously, according to this alternative form of embodiment, the pitch p₂ and the pitch p₃ are identical.

Advantageously also according to this alternative form of embodiment, the cord is a 19.20 unwrapped metal cord of formula 1.22+6.20+12.20, the layers being formed with the same direction of rotation and with identical pitches. Such a cord in allows the formation of a bead wire by winding a first turn of 1 to 4 cords or 2 to 4 turns of cords to form a first layer, and so on in order to form n layers. The number n of layers may be comprised between 1 and 4. This number of turns/cords/layers required is dependent on the size of tire and its use.

According to a first alternative form, after the tire has been collapsed, the mean line of the bead wire comprises a concave part P_{c} of smaller radius R_{c1} and of centre of curvature C_{c1}. The bead wire also comprises two convex parts Pₓ₁, Pₓ₂, respectively of smaller radii Rₓ₁, Rₓ₂, and of centres of curvature Cₓ₁, Cₓ₂. The straight lines D₁, D₂ respectively connecting the centre of curvature C_{c1} of the concave part P_{c} to each of the centres of curvature Cₓ₁, Cₓ₂ of the convex part Pₓ form an angle α comprised between 5 and 40°. The geometric shape of the collapsed tire in this first alternative form closely resembles a U-shape or a J-shape depending on whether the straight lines D₁ and D₂ are the same length or different lengths.

According to a second alternative form, for preference, after the tire has been collapsed, the mean line of the bead wire comprises a concave part P_{c} of smaller radius R_{c1} and of centre of curvature C_{c1}. The bead wire comprises two convex parts Pₓ₁, Pₓ₂, respectively of smaller radii Rₓ₁, Rₓ₂, and of centres of curvature Cₓ₁, Cₓ₂. The straight lines D₁, D₂ respectively connecting the centre of curvature C_{c1} of the concave part P_{c} to each of the centres of curvature Cₓ₁, Cₓ₂ of the convex part Pₓ may form an angle α comprised between 50 and 85°, and are preferably of different lengths. The geometric shape of the collapsed tire according to this second alternative form of collapse closely resembles a spiral shape.

Finally, according to an alternative form of the invention, after the tire has been collapsed, the mean line of the bead wire may comprise two concave parts P_{c1}, P_{c2}, respectively of smaller radii R_{c1}, R_{c2} and of centres of curvature C_{c1}, C_{c2}. It also comprises two convex parts Pₓ₁, Pₓ₂, respectively of smaller radii Rₓ₁, Rₓ₂, and of centres of curvature Cₓ₁, Cₓ₂. The straight lines D₁, D₂ respectively connecting the centre of curvature C_{c1} of a concave part to each of the centres of curvature Cₓ₁, Cₓ₂ of the convex parts Pₓ₁, Pₓ₂ preferably form an angle α comprised between 95° and 130°, and are not the same length. The geometric shape of the collapsed tire according to this last alternative form closely resembles an S-shape.

For each of the alternative forms, the range of values for the angle α makes it possible both to guarantee that the tire, for certain sizes, runs no risk of any impairment when left collapsed for a lengthy period of time and also to guarantee a significant gain in the amount of compacting.

When collapsed substantially into a U-shape or J-shape, the ratio D₁/D₂ may be equal to 1.

When collapsed substantially into the shape of a spiral, the ratio D₁/D₂ may tend towards zero. It is preferably comprised between 0.15 and 1.

When it is collapsed substantially into an S-shape, the ratio D₁/D₂ may tend towards an infinite value. It is preferably comprised between 1 and 12.

The tire according to an embodiment of the invention preferably, after collapse, occupies a volume less than 65% per m³ by comparison with the lacing mode of packaging.

### BRIEF DESCRIPTION OF DRAWINGS

The invention will now be illustrated with the aid of various detailed embodiments that follow and which do not in any way limit the subject matter of the invention.

The various measurements that follow have been taken on tires, collapsed according to the invention, of different sizes.

FIG. 1 depicts a schematic view, in cross section on a radial plane, of a tire for a motorized two-wheeled vehicles, not collapsed,

FIG. 2 depicts a schematic view, in cross section on a circumferential plane, of the collapsed tire of the invention according to a first embodiment,

FIG. 3 depicts a schematic view, in cross section on a circumferential plane, of the collapsed tire of the invention according to a second embodiment,

FIG. 4 depicts a schematic view in cross section, on a circumferential plane, of the collapsed tire according to the invention, according to a third embodiment,

FIGS. 5A, 5B, 5C, 5D, 5E, and 5F each depict a schematic view of the various steps of a method of collapsing, according to an embodiment of the invention, the tire.

### DETAILED DESCRIPTION OF SPECIFIC EMBODIMENTS

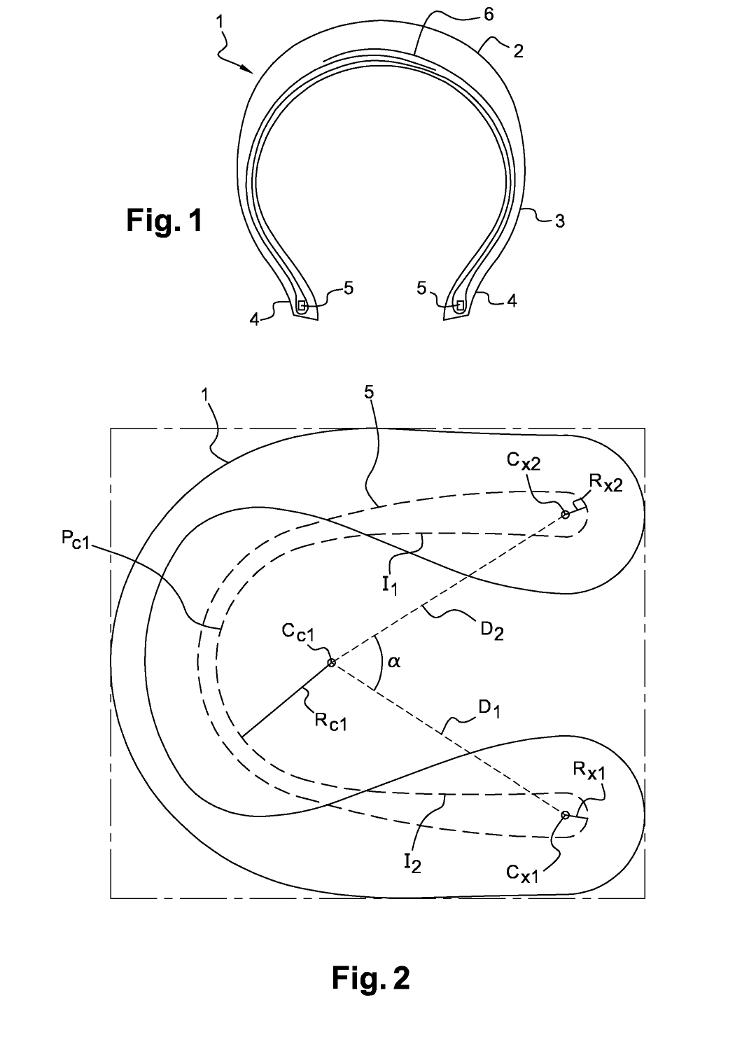

FIG. 1 shows a light motorcycle tire, of general reference 1, in the uncollapsed state, comprising a tread 2 extended radially inwards by two sidewalls 3 connected to two beads 4, the said beads 4 comprising a bead wire (reinforcing element) 5.

In FIG. 1, there is a carcass ply 6 radially on the inside of the tread 2. An inextensible crown ply (not depicted), which is not always present, is arranged radially on the outside of the carcass ply 6.

The crown and carcass reinforcements 6 are each made up of at least one layer of reinforcing elements (not depicted). The tread 2 is connected to the beads 4 by two sidewalls 3. Each bead 4 has at least one bead wire 5. This bead wire 5, which defines a mean line forming a substantially circular closed curve in a circumferential plane, is inextensible and flexible.

The bead wire preferably is made of steel, and is in the form of an unwrapped cord formed of filaments, the said filaments having a diameter equal to 0.20 mm. The cord is a 19.20 metal cord of formula 1.22+6.20+12.20, the layers being formed with the same direction of rotation and with identical pitches of 10 mm. Such a cord allows the formation of a bead wire by winding 3 to 16 turns. The number of turns required is dependent on the size of tire and its use.

The mean thickness E_{F} of the sidewall (which combines that of the sidewall and that of the carcass ply) of the tire according to an embodiment of the invention, measured at the point located in the middle, in the radial direction, between the high point of the bead wire and the low point of the tire on the equatorial plane, is between 2 and 7 mm.

The mean thickness E_{S} of the crown reinforcement (which optionally comprises a crown ply), measured in the equatorial plane, is between 2 and 5 mm.

In FIG. 2, the mean line of the bead wire 5 (depicted in large dashed line) of the tire, of trade reference 150/70-14, collapsed according to a first mode of collapse, roughly into a U-shape, has a concave part P_{c1} of smaller radius R_{c1} equal to 45 mm and a centre of curvature C_{c1}.

The mean line of the bead wire 5 comprises, on the one hand, two points of inflexion I₁, I₂ which delimit the concave part P_{c1} and, on the other hand, two convex parts Pₓ₁, Pₓ₂ having two smaller radii Rₓ₁ comprised between 20 and 30 mm and Rₓ₂ comprised between 20 and 30 mm and two centres of curvature Cₓ₁ and Cₓ₂.

Two straight lines D₁ and D₂ which respectively connect the centre of curvature C_{c1} of the concave part P_{c1} to each of the centres of curvature Cₓ₁ and Cₓ₂ of the convex part Pₓ₁ form an angle α of around 15°. In this mode of collapse the straight lines D₁ and D₂ are substantially the same length, and measure 240 mm.

Having been collapsed according to this first mode of collapse, the tires can also be nested in one another or even possibly laced. Lacing makes it possible to keep them compressed.

Table I below collates other measurements taken on the form of collapse depicted in FIG. 2 (U-shape).

TABLE I

| | Sidewall | Crown | | | | | | | |
|---|---|---|---|---|---|---|---|---|---|
| | thickness | reinforcement | Angle | D₁ | D₂ | R_{c1} | Rₓ₁ | Rₓ₂ | |
| | (in mm) | thickness (in | (α in | (in | (in | (in | (in | (in | |
| Size of tire | E_{F} | mm) Eₛ | degrees) | mm) | mm) | mm | mm) | mm) | D₁/D₂ |
| 2.00-17 | 2.6 | 2.3 | 5 | 320 | 320 | 30 | 20 | 20 | 1 |
| 150/70-14 | 6 | 4 | 15 | 240 | 240 | 45 | 30 | 30 | 1 |

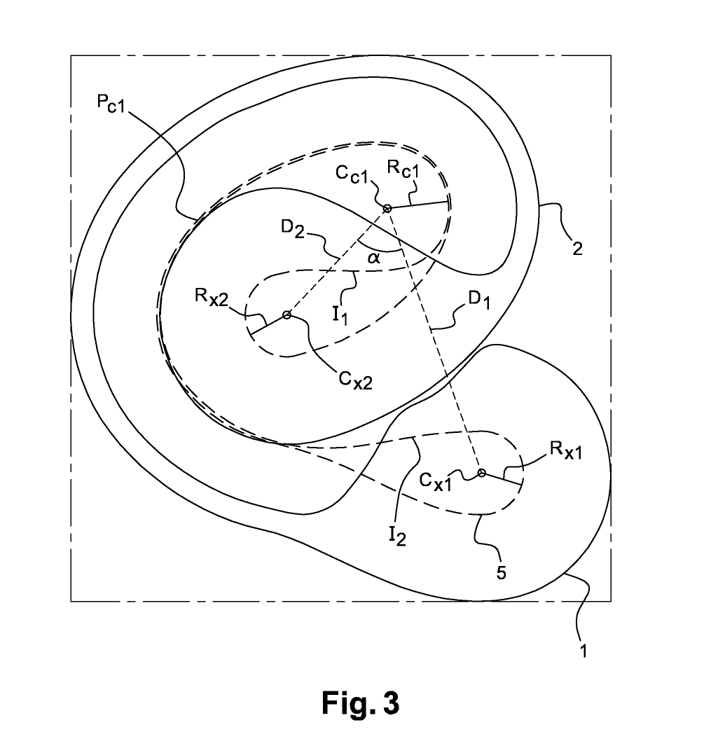

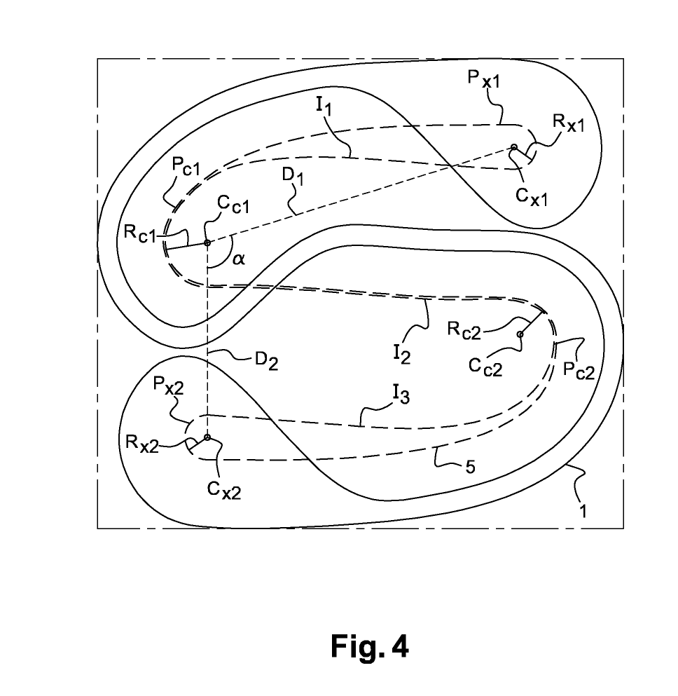

The collapsing of the tire 1 as depicted in FIG. 3 differs from that of FIG. 2 in that the straight lines D₁ and D₂ form an angle α comprised between 50° and 85°, and in that they do not have the same length. The collapsing as depicted in FIG. 4 closely resembles the shape of a spiral.

The volume occupied by the tire is less than 85%, preferably less than 75% of the volume occupied by tires collapsed according to the currently known modes of packaging.

Table II below collates the measurements taken on various tires according to the form of collapse depicted in FIG. 3 (spiral shape).

TABLE II

| | Sidewall | Crown | | | | | | | |
|---|---|---|---|---|---|---|---|---|---|
| | thickness | reinforcement | Angle α | D₁ | D₂ | R_{c1} | Rₓ₁ | Rₓ₂ | |
| | (in mm) | thickness (in | (in | (in | (in | (in | (in | (in | |
| Size of tire | E_{F} | mm) E_{S} | degrees) | mm) | mm) | mm) | mm) | mm) | D₁/D₂ |
| 2.00-17 | 2.6 | 2.3 | 85 | 30 | 200 | 30 | 20 | 20 | 0.15 |
| 150/70-14 | 6 | 4 | 65 | 75 | 100 | 45 | 30 | 30 | 0.75 |

The third mode of collapsing the tire 1, as depicted in FIG. 4, differs from that of FIG. 2 in that the mean line of the bead wire 5 comprises two concave parts P_{c1}, P_{c2}. The concave parts P_{c1} and P_{c2} are characterized by a smaller radius.

The mean line of the bead wire 3 also comprises two convex parts Pₓ₁, Pₓ₂ respectively having a smaller radius Rₓ₁ comprised between 20 and 30 mm, and Rₓ₂ comprised between 20 and 30 mm, and respectively having a centre of curvature Cₓ₁, Cₓ₂.

In FIG. 4, the mean line of the bead wire 3 comprises three points of inflexion I₁, I₂ and I₃ which delimit a concave part from a convex part and vice versa.

According to this third mode of collapse, the straight lines D₁ and D₂ which respectively connect the centre of curvature C_{c1} of a concave part P_{c1} to each of the centres of curvature Cₓ₁, Cₓ₂ of the convex parts Pₓ₁ and Pₓ₂ form an angle α comprised between 95° and 130°. The straight lines D₁ and D₂ are not of the same length.

The volume occupied by the tire is less than 80%, preferably less than 70% by comparison with the volume occupied by tires collapsed according to currently known modes of compacting.

Table III below collates the measurements taken on various tires according to the form of collapse depicted in FIG. 4 (S-shape).

TABLE III

| | Sidewall | Crown | | | | | | | |
|---|---|---|---|---|---|---|---|---|---|
| | thickness | reinforcement | Angle α | D₁ | D₂ | R_{c1} | Rₓ₁ | Rₓ₂ | |
| | (in mm) | thickness (in | (in | (in | (in | (in | (in | (in | |
| Size of tire | E_{F} | mm) E_{S} | degrees) | mm) | mm) | mm) | mm) | mm) | D₁/D₂ |
| 2.00-17 | 2.6 | 2.3 | 95 | 220 | 30 | 30 | 20 | 20 | 7.3 |
| 150/70-14 | 6 | 4 | 115 | 120 | 75 | 45 | 30 | 30 | 1.6 |

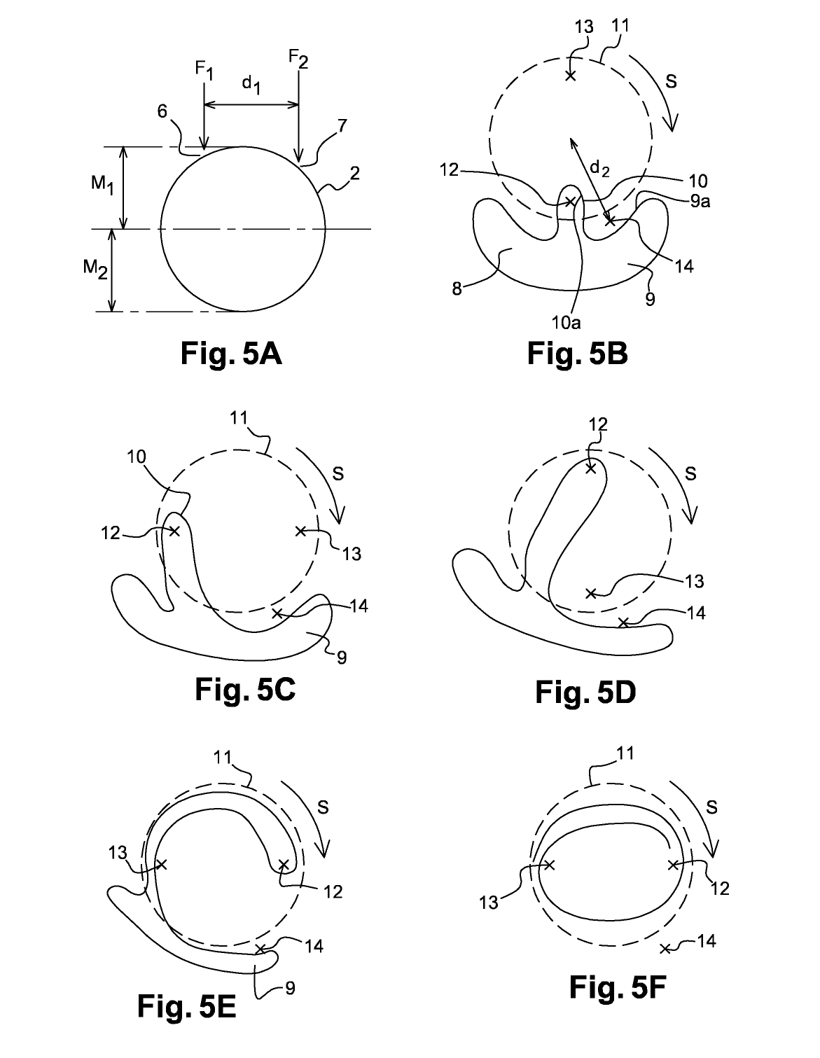

The method of collapse set out hereinbelow with reference to FIGS. 5A to 5F may be envisaged in order to obtain a tire collapsed according to an embodiment of the invention.

First of all, in a radial plane, the beads of a first half M₁ of the tire are parted in an axial direction towards an axis tangential to the centre of the tread.

As then shown by FIG. 5A which in a very stylized manner depicts a tire in lateral view prior to collapsing, a radial force is then applied in two parallel directions F1 and F2 of identical sense at two spaced-apart points 6, 7 on the tread 2 of the said first half M₁. The two points are spaced apart by a distance d₁ of around 100 mm.

As FIG. 5B shows, the application of this force to the points 6 and 7 on the tire, in lateral view, allows the first half M₁, axially on the outside of the tread 2, to be brought closer to the axially inner second half M₂ opposite, at these two points 6 and 7. This moving-together makes it possible simultaneously to form a first zone 8, a second zone 9 and a protrusion 10 situated between these zones 8 and 9. The tire, having thus been prepared in advance for collapsing, substantially resembles a semicircle comprising a protuberance in its central part.

This pre-collapsed tire is then placed on a substantially circular flat rotary means 11. FIG. 5B depicts a view from above of the rotary means on which the pre-collapsed tire is placed. This rotary means 11 comprises a first axis 12 and a second axis 13, both vertical, diametrically opposed, and mobile. A third vertical axis 14, which is fixed, is arranged a distance d2 closest to the rotary means 11. The distance between the first axis 12 and second axis 13 is preferably equal to the length of the straight line D2 defined previously on the collapsed tire.

The direction S of rotation of the rotary means 11 is directed towards the second vertical axis 14 as mentioned in FIGS. 5B to 5E.

The internal part 10a of the protuberance 10 then finds itself “straddling” the first vertical axis 12. The internal part 9a of the closer-together zone 9 of the tire at the same time comes to press against the vertical axis 14. The second half M₂ of the tire is moreover preferably held in the pre-collapsed position by the said means during the steps of collapsing.

The method of collapsing the tire prearranged in this way works as follows.

Once the tire has been pre-collapsed, placed on the rotary means 11, it is made to rotate.

FIG. 5C depicts a rotation of the rotary means 11 by one quarter of a turn in relation to FIG. 5B. As this rotary means 11 is set in rotation in the direction S directed towards the vertical axis 14, the protuberance 10 of the tire is driven in rotation by the first vertical axis 12. Zone 9 is at the same time kept pressed against the vertical axis 14 throughout the rotation phase.

FIG. 5D, which depicts a rotation of the rotary means 11 through half a turn in relation to FIG. 5B, shows how the tire is progressively coiled on itself, the zone 9 still being kept pressed against the vertical axis 14.

FIG. 5E, which represents a rotation of the rotary means 11 by three quarters of a turn in relation to FIG. 5B, shows the coiling of the tire progressively. The zone 9 is still kept pressed against the vertical axis 14. Unlike the vertical axis 12 which is surrounded by the protuberance 10, the second vertical axis 13 allows the movement of coiling the tire to be begun and maintained, while at the same time remaining completely radially on the outside of the tread 2.

FIG. 5F depicts the tire in the fully collapsed state. Depending on the type of tire being collapsed, it is necessary to perform at least one revolution of the rotary means 11 in order to collapse it. For preference, one revolution will be performed for a collapsing according to the embodiment of FIG. 2, and at least one and a half revolutions will be performed for a collapsing according to the embodiment of FIG. 3.

For example, for a tire of commercial reference 2.75-17 it is necessary to rotate the rotary means through one and half revolutions.

At the end of collapsing, the tire may possibly be held in the collapsed state by any holding means which may be installed automatically and/or by hand.

1. A collapsible tire for a two-wheeled vehicle of the motorbike type, comprising:
a carcass reinforcement surmounted radially on the outside by an optional inextensible crown reinforcement having a thickness comprised between 2 and 7 mm, wherein the reinforcements each comprise at least one layer of reinforcing elements,
a tread radially on the outside of the optional inextensible crown reinforcement and connected to two sidewalls, each having a thickness between 2.6 and 7 mm,
the two beads each connected by a sidewall to the tread, and adapted to come into contact with a rim, each bead comprising at least one inextensible circumferential reinforcing element called a bead wire, wherein the bead wire defines a mean line forming a substantially circular closed curve in a circumferential plane, is flexible, wherein after the tire has been collapsed, the mean line of the bead wire comprises at least one concave part P_{c} of smaller radius R_{c} and of center of curvature C_{c}, wherein the bead wire comprises at least one unwrapped metal cord the carbon content of which is between 0.5 and 0.9%.

2. The tire according to claim 1, wherein the mean line of the bead wire further comprises at least two points of inflexion I₁, I₂ delimiting the concave part P_{c}.

3. The tire according to claim 1, wherein the mean line of the bead wire further comprises at least two convex parts Pₓ₁, Pₓ₂ having two smaller radii Rₓ₁, Rₓ₂ and two centers of curvature Cₓ₁, Cₓ₂, and wherein straight lines D₁, D₂ respectively connecting the center of curvature C₁ of the concave part P_{c} to each of the centers of curvature Cₓ₁, Cₓ₂ of the convex parts Pₓ₁, Pₓ₂ form an angle α between 5° and 130°.

4. The tire according to claim 1, wherein the mean line of the bead wire of each bead is formed by winding a metal cord, formed of filaments, which is saturated and unwrapped, wherein the diameter of the metal cord is less than 1.5 mm, and wherein the diameter of the filament is less than 0.22 mm.

5. The tire according to claim 1, wherein after the tire has been collapsed, the mean line of the bead wire comprises a concave part P_{c} of smaller radius R_{c1} and of center of curvature C_{c1}, wherein the mean line of the bead wire comprises two convex parts Pₓ₁, Pₓ₂, respectively of smaller radii Rₓ₁, Rₓ₂, and of centers of curvature Cₓ₁, Cₓ₂, and wherein straight lines D₁, D₂ respectively connecting the center of curvature C_{c1} of the concave part P_{c} to each of the centers of curvature Cₓ₁, Cₓ₂ of the convex part Pₓ form an angle α between 5 and 40°.

6. The tire according to claim 1, wherein after the tire has been collapsed, the mean line of the bead wire comprises a concave part P_{c} of smaller radius R_{c1} and of center of curvature C_{c1}, wherein the mean line of the bead wire comprises two convex parts Pₓ₁, Pₓ₂, respectively of smaller radii Rₓ₁, Rₓ₂, and of centers of curvature Cₓ₁, Cₓ₂, and wherein straight lines D₁, D₂ respectively connecting the center of curvature C_{c} of the concave part P_{c} to each of the centers of curvature Cₓ₁, Cₓ₂ of the convex part Pₓ form an angle α between 50 and 85°.

7. The tire according to claim 1, wherein after the tire has been collapsed, the mean line of the bead wire comprises two concave parts P_{c1}, P_{c2}, respectively of smaller radii R_{c1}, R_{c2} and of centers of curvature C_{c1}, C_{c2}, wherein the mean line of the bead wire comprises two convex parts Pₓ₁, Pₓ₂, respectively of smaller radii Rₓ₁, Rₓ₂, and of centers of curvature Cₓ₁, Cₓ₂, and wherein straight lines D₁, D₂ respectively connecting the center of curvature C_{c1} of a concave part to each of the centers of curvature Cₓ₁, Cₓ₂ of the convex parts Pₓ₁, Pₓ₂ form an angle α between 95° and 130°.

8. The tire according to claim 1, wherein after collapsing, the ratio D₁/D₂ of the lengths of straight lines D₁, D₂ respectively connecting the center of curvature of the concave part to each of the centers of curvature of the convex parts tends towards zero or towards infinity.

9. The tire according to claim 1, wherein after collapsing, the tire occupies a volume less than 65% per m³ by comparison with the lacing mode of packaging.

10. A method for collapsing a tire according to claim 1, comprising:
a) parting, in a radial plane, the beads of a first half of a tire in an axial direction towards an axis tangential to the center of the tread,
b) applying a force in two parallel radial directions of identical sense, at two spaced-apart points on the tread of a first half (M₁) so as to bring the first half (M₁) of the parted tread closer to a second half (M₂) opposite the first half (M₁) at these two points, thus forming a first and a second closer-together zone, while at the same time keeping the tread between these two points in the form of a protrusion,
arranging the internal part of the said protrusion on each side of a first vertical axis and, at the same time, causing to bear against a third vertical axis that is fixed, one of the closer-together zones, the first axis being arranged diametrically to a second axis, the first and second vertical axes being placed on a flat means able to function in rotation,
d) causing the flat means to effect at least one rotation so as to collapse the tire by coiling it on itself about the first and third vertical axes.

11. The method according to claim 10, wherein the flat means rotates in a direction that is directed towards the third vertical axis.

12. A method of using the tire according to claim 1 comprising installing the tire on a vehicle of the motorized two-wheeled vehicle type.
